(19) United States
(12) Patent Application Publication
(10) Pub. No.: US 2024/0065481 A1
(43) Pub. Date: Feb. 29, 2024

(54) COFFEE GRINDER WITH AUTOMATIC DOSE CONTROL SYSTEM

(71) Applicant: CONTI VALERIO - S.R.L., Sesto Fiorentino (FI) (IT)

(72) Inventor: Maurizio FIORANI, Milano (IT)

(21) Appl. No.: 18/458,434

(22) Filed: Aug. 30, 2023

(30) Foreign Application Priority Data
Aug. 31, 2022 (IT) 102022000017913

(51) Int. Cl. A47J 42/44; A23F 5/08; A47J 42/40; A47J 42/46

(52) U.S. Cl. CPC A47J 42/44; A23F 5/08; A47J 42/40; A47J 42/46

(57) ABSTRACT

Disclosed is a coffee grinder having an automatic coffee dose control system that provides for comparing a difference between an ideal weight set by a user and an actual weight measured by a load cell with an error; if the difference between the ideal weight and the actual weight is greater than the error, an extra-dose of coffee powder is dispensed.

### FIELD OF THE INVENTION

The present invention relates to a coffee grinder with an automatic dose control system.

### BACKGROUND OF THE INVENTION

Coffee grinders provided with a support to support a filter holder suitable for being filled with a dose of ground coffee are commercially known. Such coffee grinders have a load cell connected to the support to weigh the ground coffee dispensed into the filter holder and to stop dispensing when the coffee weight reaches a preset dose.

EP3023041A1 in the name of Simonelli Group S.P.A. describes such a type of coffee grinder with a load cell.

When the grinder of the coffee grinder is stopped, due to inertia the grinder continues to rotate and thus a small amount of ground coffee continues to flow out of the dispensing duct. For such a reason, the grinder group must be stopped in advance to avoid exceeding the required amount of coffee. Such an advance is known as “time-of-flight”.

To comply with the time-of-flight, the load cell can be calibrated to a slightly lower weight than the weight of one coffee dose, i.e. a tare weight equal to the weight of coffee dispensed during the time-of-flight is subtracted from the weight of a dose.

However, the time-of-flight is not constant for all types of coffee, but depends on the grain size of the ground coffee. The finer the grain size, the greater the time-of-flight to be considered will be. In addition, the time-of-flight also depends on the mechanical structure of the grinder and on the electronics driving the grinder. Therefore, the coffee grinders of the prior art generally have errors and inaccuracies in the dosing system, which are mainly due to an incorrect calculation of the time-of-flight.

### BRIEF SUMMARY OF THE INVENTION

The purpose of the present invention is to eliminate the drawbacks of the prior art by providing a coffee grinder with an automatic dose control system that is accurate and reliable.

Another purpose is to provide such a coffee grinder that is capable of automatically controlling the dispensing of a dose of ground coffee, regardless of both the grain size of the coffee and the mechanics and electronics of the coffee grinder.

Still another purpose of the present invention is to provide such a coffee grinder that is easy to manufacture and simple to use.

These purposes are achieved in accordance with the invention with the features of the appended independent claims.

Advantageous achievements of the invention appear from the dependent claims.

### BRIEF DESCRIPTION OF THE SEVERAL VIEWS OF THE DRAWINGS

Further features of the invention will appear clearer from the following detailed description, referring to a purely illustrative and therefore non-limiting embodiment, illustrated in the appended drawings, wherein:

FIG. 1 is a diagrammatic side view of a coffee grinder according to the invention.

FIG. 2 is a block diagram of the coffee grinder of FIG. 1.

FIG. 3 is a flowchart illustrating a first operational step of the coffee grinder of FIG. 1.

FIG. 4 is a flowchart illustrating a second operational step of the coffee grinder of FIG. 1.

### DETAILED DESCRIPTION OF THE INVENTION

With the aid of the Figures, the coffee grinder according to the invention is described, it being comprehensively indicated by reference number 100.

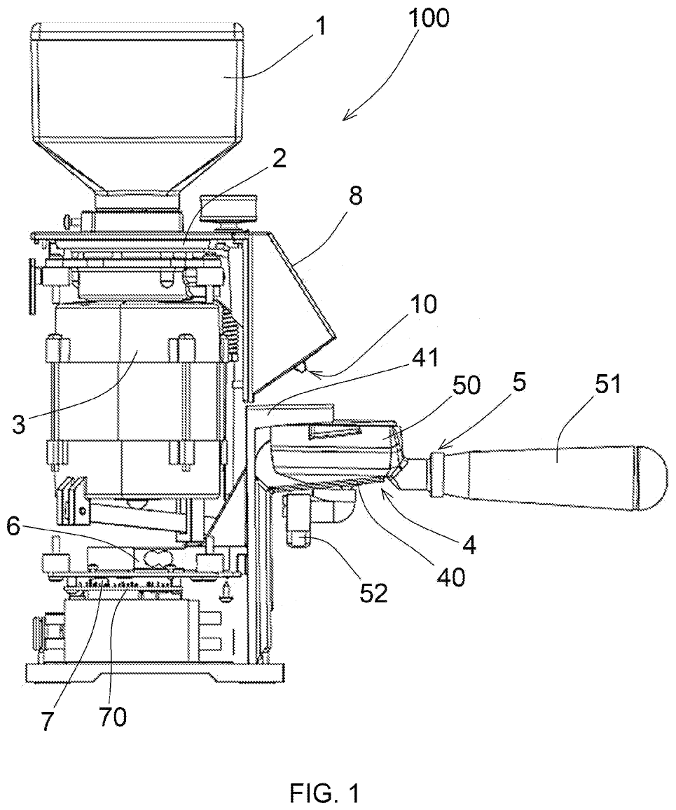

Referring to FIG. 1, the coffee grinder (100) comprises:
a hopper (1) for loading the coffee beans,
a grinder (2) to grind the coffee beans into coffee powder,
an electric motor (3) to drive the grinder (2),
a dispensing unit (10) to dispense the coffee powder,
a support (4) to support a filter holder (5) under the dispensing unit (10),
a load cell (6) connected to the support (4) to weigh the coffee powder inside the filter holder (5),
a control unit (7) electrically connected to the load cell (6), and
a user interface (8) connected to the control unit (7).

The filter holder (5) is a typical filter holder for a coffee machine. The filter holder (5) comprises:
a container (50) that is basically cylindrical,
a handle (51) that protrudes radially from the container, and
a dispensing nozzle (52) that protrudes inferiorly from the container to dispense the liquid coffee.

The support (4) comprises:
a fork (40) suitable for supporting the container (50) of the filter holder, and
a bracket (41) that connects the fork (40) to the load cell (6).

The load cell (6) is connected to a printed circuit board (PCB) (70) on which the control unit (7) is mounted.

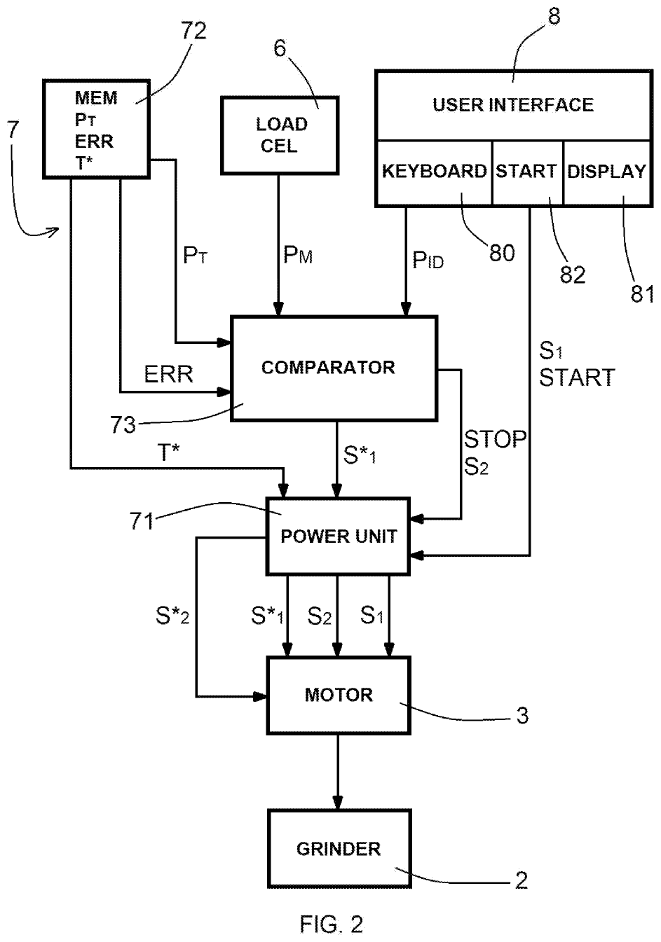

Referring to FIG. 2, the control unit (7) comprises:
a power unit (71) to drive the electric motor (3),
a memory (72) in which some operating parameters of the coffee grinder are stored, and
a comparator (73) to perform comparisons between parameters and variables.

The user interface (8) comprises:
a keyboard (80) used by the user to enter an ideal weight (PID) of a coffee dose,
a display (81) to display the ideal weight entered by the user,
a start button (82) to start the grinding cycle.

The following parameters are stored in the memory (72):
a tare weight (P_{T}) that considers the time-of-flight of the grinder,
an error (ERR) that considers a permissible error with respect to the ideal weight (P_{ID}) entered by the user, and
an extra-dose time (T*) that considers an operating time of the grinder (2) for the grinder to make an extra run to dispense an extra-dose of ground coffee.

The time-of-flight is the time in which the grinder (2) continues to rotate by inertia after the motor (3) is turned off. The tare weight (P_{T}) is a weight of the coffee that is ground during the time-of-flight, increased by a correction factor so as to consider an advance over the time-of-flight. The correction factor ensures that at the end of grinding operation, the actual weight of the coffee dose in the filter holder does not exceed the desired ideal weight. The tare weight (P_{M}) is set by the machine manufacturer based on experimental tests done with coffee grinders in the case of grinding the beans for an espresso coffee.

The error (ERR) is calculated based on experimental tests done on the quality of the liquid coffee obtained with doses that are different from the ideal dose. It was found that if the error is kept, for example, in the range of about 0.05-0.3 grams, preferably 0.2 grams, the quality of the liquid coffee is still acceptable.

The extra-dose time (T*) is calculated for the grinder (2) to make an extra run, dispensing a minimum amount of coffee powder (extra-dose), i.e., an amount of coffee powder less than the error (ERR). By way of example, the time-dose (T*) is calculated to dispense 0.1 gram of coffee powder.

Now with reference to FIGS. 2, 3 and 4, the operation of the coffee grinder (100) is described.

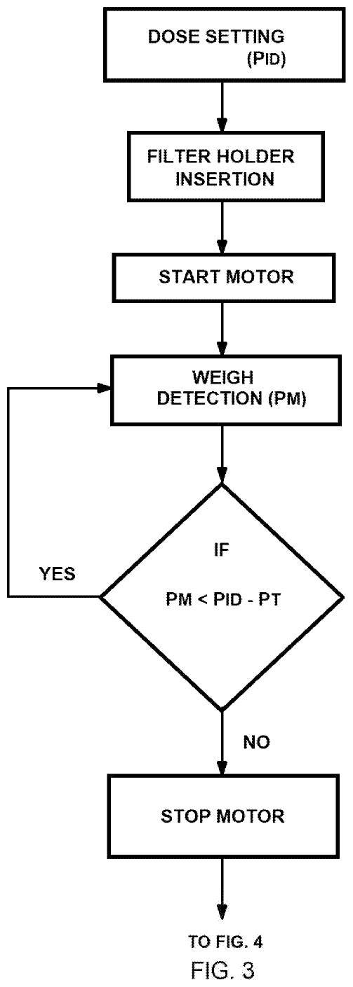

Referring to FIGS. 2 and 3, the user enters the ideal weight (P_{ID}) of the coffee powder dose to be obtained using the keyboard (80) of the user interface, and reads the ideal weight on the display (81).

Then the user inserts the filter holder (5) into the support (4) and presses the start button (82), which generates a start signal (S1) to the power unit (71) that drives the motor (3) that moves the grinder (2). The grinder grinds the coffee beans into coffee powder that is dispensed from the dispensing unit (10) and falls into the container (50) of the filter holder.

When the coffee powder is dispensed from the dispensing unit (10) and falls into the filter holder (5), the load cell (6) continuously detects the actual weight (P_{M}) of the coffee powder in the filter holder.

The comparator (73) is configured to compare the real weight (P_{M}) detected by the load cell with the ideal weight (P_{ID}) set by the user minus the tare weight (P_{T}) which is a machine parameter.

When the actual weight (P_{M}) is equal to the ideal weight (P_{ID}) minus the tare weight (P_{T}), then the comparator (73) sends a stop signal (S2) to the power unit (71), which stops the motor (3) of the grinder (2). So the grinder (2) is stopped early, when still the weight of the coffee in the filter holder has not reached the ideal weight (P_{ID}). During the time-of-flight, the grinder continues to rotate by inertia and more coffee powder is dispensed and falls into the filter holder (5).

Obviously, it cannot be predicted whether at the end of the time-of-flight the weight of coffee in the filter holder is exactly equal to the ideal weight (P_{ID}). However, since a correction factor has been added in the tare weight (P_{T}), presumably the amount of coffee in the filter holder should have a slightly lower weight than the ideal weight (P_{ID}) and it might be necessary to add one or more extra-doses to approximate the ideal weight.

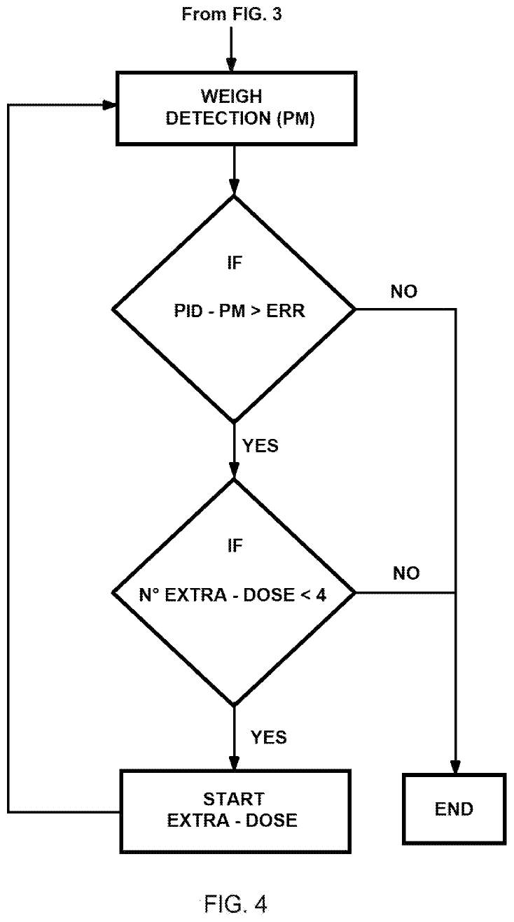

With reference to FIGS. 2 and 4, after a waiting time of 1 second, for instance, after the engine has stopped, the load cell (6) weighs the coffee in the filter holder again, i.e., it weighs the actual weight (P_{M}).

At this point, the comparator (73) is configured to compare the difference between the ideal weight (P_{ID}) and the actual weight (P_{M}) with the error (ERR).

If the difference between the ideal weight (P_{ID}) and the actual weight (P_{M}) is less than or equal to the error (ERR):

P_{ID}−P_{M}<ERR

in such a case, it means that the tare weight (P_{T}) was set correctly for that type of grinding and therefore no extra-dose is needed to correct the amount of coffee powder dispensed. Therefore, the dispensing cycle of coffee powder is ended.

Instead, if the difference between the ideal weight (P_{ID}) and the actual weight (P_{M}) is greater than the error (ERR):

P_{ID}−P_{M}>ERR,

in such a case it means that the tare weight (P_{T}) is not set correctly for that type of grinding and therefore one or more extra-doses of ground coffee is necessary to correct the amount of coffee powder dispensed so far. Therefore, the comparator (73) sends an extra-dose start signal (S1*) to the power unit (71) and the power unit (71) drives the motor (3) of the grinder for an extra-dose time (T*) to dispense an extra-dose. Otherwise said, after the extra-dose time (T*), the power unit (71) sends an extra-dose stop signal (S2*) and the motor (3) stops.

At this point, the filter holder (5) is weighed again to detect whether, after the addition of the first extra-dose, the difference between the ideal weight (P_{ID}) and the actual weight (P_{M}) is less than or equal to the error (ERR). In case the difference between the ideal weight (P_{ID}) and the actual weight (P_{M}) is greater than the error (ERR), a second extra-dose is dispensed.

Such an extra-dose dispensing cycle is performed for a limited number of times, such as four times.

Equivalent variations and modifications may be made to the present embodiment of the invention, within the scope of an expert of the field, but still within the scope of the invention as expressed by the appended claims.

I claim:

1. Coffee grinder comprising:
a hopper to load coffee beans;
a grinder to grind the coffee beans into coffee powder;
an electric motor to operate the grinder;
a dispenser unit to dispense the coffee powder;
a support to support a filter holder under the dispenser unit;
a load cell connected to the support to weigh the coffee powder in the filter holder, so as to have an actual weight of the coffee in the filter holder;
a control unit electrically connected to the load cell; and
a user interface connected to the control unit;
wherein said control unit comprises:
a power unit to drive the electric motor;
a memory in which operating parameters of the coffee grinder are stored; and
a comparator to perform comparisons between parameters and variables;
wherein said user interface includes:
a keyboard used by the user to enter an ideal weight of a coffee dose;
a display to display the ideal weight entered by the user;
a start button to start the grinding cycle;
the following parameters being stored in said memory:
a tare weight that considers the time-of-flight of the grinder;
an error that considers a permissible error with respect to the ideal weight entered by the user; and
an extra-dose time that considers an operation time of the grinder in order to drive the grinders in an extra-run to dispense an extra-dose of ground coffee;
said comparator being configured so that:
(A) after the start button is pressed, the comparator compares the actual weight detected by the load cell with the ideal weight (P_{ID}) set by the user minus the tare weight, and when the actual weight is equal to the ideal weight minus the tare weight, then the comparator sends a stop signal to the power unit which stops the motor of the grinder;
(B) after a waiting time from the stop signal, the comparator compares the difference between the ideal weight and the actual weight with the error; if the difference between the ideal weight and the actual weight is lower than or equal to the error, the dispensing cycle of coffee powder is ended;
if the difference between the ideal weight (P_{ID}) and the actual weight is greater than the error, the comparator sends an extra-dose start signal to the power unit, and the power unit drives the motor of the grinder for an extra-dose time to dispense an extra-dose, and after the extra-dose time, the power unit sends an extra-dose stop signal and the motor stops;
after a waiting time from the extra-dose stop signal (S2*), the load cell weighs the filter holder and the comparator evaluates whether the difference between the ideal weight and the actual weight is lower than or equal to the error; in case the difference between the ideal weight and the actual weight is greater than the error, a second extra-dose is dispensed, otherwise the dispensing cycle is ended;
said extra-dose dispensing cycle is performed for a limited number of times.

2. The coffee grinder according to claim 1, wherein said error is set in the range from 0.05 to 0.3 g.

3. The coffee grinder according to claim 1, wherein said extra-dose time is calculated so that the grinder makes an extra run, dispensing an amount of coffee powder that is lower than the error.

4. The coffee grinder according to claim 1, wherein said tare weight is equal to a weight of ground coffee dispensed during an experimentally calculated time-of-flight, increased by a correction factor so as to consider an advanced stop of the grinder with respect to the time-of-flight.

5. The coffee grinder (100) according to claim 4, wherein said correction factor of the tare weight (P_{T}) is 0.05-0.1 g.

6. Method for dispensing a dose of ground coffee with a coffee grinder according to claim 1, comprising the following steps:
a) setting an ideal weight of a coffee dose;
b) inserting the filter holder into the support of the coffee grinder;
c) starting the motor of the grinder;
d) detecting the actual weight of the coffee powder in the filter holder;
e) comparing the actual weight with the ideal weight minus the tare weight;
f) stopping the motor of the grinder when the actual weight equals the ideal weight minus the tare weight;
g) waiting for a waiting time from stopping the motor;
h) detecting the actual weight of the coffee powder in the filter holder;
i) comparing the difference between the ideal weight and the actual weight with the error; if the difference between the ideal weight and the actual weight is lower than or equal to the error, the dispensing cycle of coffee powder is ended;
j) dispensing an extra-dose of coffee powder in the filter holder for an extra-dose time, if the difference between the ideal weight and the actual weight is greater than the error;
k) waiting for a waiting time after dispensing the extra-dose and returning to step h);
wherein said dispensing cycle of extra-doses from step h) to step k) is performed for a limited number of times and then is ended.

7. The method according to claim 6, wherein said error is set in the range from 0.15 to 0.3 g.

8. The method according to claim 6, wherein said extra-dose time is calculated so that the grinder makes an extra run, dispensing an amount of coffee powder lower than the error.

9. The method according to claim 6, wherein said tare weight is equal to a weight of ground coffee dispensed during an experimentally calculated time-of-flight, increased by a correction factor so as to consider an advanced stop of the grinder with respect to the time-of-flight.

10. The method according to claim 9, wherein said correction factor of the tare weight is 0.05-0.1 g.

11. The method according to claim 7, wherein said error is set at 0.2 g.
